(19) United States
(12) Patent Application Publication
(10) Pub. No.: US 2022/0040559 A1
(43) Pub. Date: Feb. 10, 2022

(54) SNAKEBOARD DEVICE

(71) Applicant: In Tae KANG, Incheon (KR)

(72) Inventor: In Tae KANG, Incheon (KR)

(21) Appl. No.: 17/296,336

(22) PCT Filed: Mar. 25, 2020
(86) PCT No.: PCT/KR2020/004035

§ 371 Date: May 24, 2021

(30) Foreign Application Priority Data
Mar. 26, 2019 (KR) 10-2019-0034694

(51) Int. Cl. A63C 17/01

(52) U.S. Cl. CPC A63C 17/016; A63C 17/223; A63C 2203/10

(57) ABSTRACT

A snake board apparatus includes: a front footboard part (100) on which a user puts one foot; a rear footboard part (200) on which a user puts the other foot; and a connecting part (300) connecting the front footboard part (100) and the rear footboard part (200) to each other. The connecting part (300) includes: a first finishing member (310) inserted into the housing (120) of the front footboard part (100); a first pipe (320) having one end portion connected to surround a portion of the first finishing member (310) and the other end portion provided with a concave part (322); a second pipe (330) having one end portion integrally provided with a first stopper (332), an outer circumferential surface provided with a coil spring (340), and the other end portion provided with a concave part (334), wherein a locking part (336) is formed at an end portion with a certain interval from the concave part, and second pipe 330 penetrating the first pipe 320 and inserted into the first pipe at a predetermined depth, and the second pipe (330) passes through the first pipe (320) and is inserted into the first pipe by a certain depth; a third pipe (370) having one end portion integrally provided with a third stopper (372) contacting the first finishing member (310), an outer circumferential surface provided with a coil spring (380), and an end portion provided with a locking part (374), wherein the third pipe (370) passes through the second pipe (330) and is inserted into the first pipe (320); a hollow second finishing member (392) inserted through the other end portion of the third pipe (370); a third finishing member (394) having a hollow cap shape and inserted into the second finishing member (392) at a certain depth; and an elastic member (396) having one end portion connected to the first finishing member (310) through the first pipe (320), the second pipe (330), and the third pipe (370), and the other end portion connected to the third finishing member (394) to prevent a separation thereof.

### TECHNICAL FIELD

The present invention relates to a snake board apparatus, and more particularly, to a snake board apparatus which allows a user to easily keep balance in a process of pushing off the ground, does not easily fatigue the user, facilitates riding regardless of age, and increases a moving speed.

### BACKGROUND ART

In recent years, extreme sports that perform various high-level stunts are becoming popular all over the world. Representative examples thereof include skate boards, bicycle motorcross (BMX), wake boards, and the like. The types of extreme sports have gradually expanded and include artificial rock climbing, snowboarding, and bungee jumping.

Among them, various types of boards are on the market due to the advantage of being relatively less constrained by places and relatively easily accessible to the general public. Such boards include skate boards, snake boards, and dancing boards.

Among them, the snake board (so-called S-board) is similar in shape to the skate board, but is completely different in the operation method from the stake board. The snake board moves forward using propelling force generated when a user propels a lower side of a board alternately from side to side while a user is riding.

In other words, the snake board has two wheels and moves forward on the flat land by using horizontal force generated when a user twists a board in an “S” shape in a way that crosses a lower body. The snake board includes a front footboard and a rear footboard. The two footboards rotate relative to each other in a twist direction to form propelling force in the wheels. This propelling force enables continuous traveling. Therefore, there is an advantage of being able to ride even in relatively narrow places.

Connecting members connecting the front footboard and the rear footboard, that is, torsion bars are coupled to the front footboard and the rear footboard, and the connecting members are located on the bottom surfaces of the front footboard and the rear footboard.

In addition, the connecting member includes a leaf spring having a certain length, and a front housing and a rear housing respectively accommodating the leaf spring and fixed to the front foot board and the rear footboard. In particular, the leaf spring connects the two housings integrally. When the two footboards coupled to the two housings are twisted in a twist direction, the two footboards are always restored to their original positions by the restoring force of the twisted leaf spring.

On the other hand, when such a snake board is used, there is an inconvenience in that a user has to repeatedly perform an operation of twisting in a twist direction while putting both feet on the two footboards in order to obtain propelling force.

That is, since the user has to continuously twist the two footboards through both feet so as to obtain continuous propelling force, the central balance may be broken in the process of pushing off the ground, and thus there is a high risk of a safety accident.

In addition, when the snake board is not used, one footboard is not parallel to the ground with respect to the connecting member and has an inclined shape with respect to the ground. Thus, in order to use the snake board, there is an inconvenience in that the snake board has to be used after rotating one inclined footboard in parallel with the ground at all times.

In addition, since the user has to constantly move both feet in order to push off the ground, there is a problem that the user gets tired easily in the process of using the snake board.

In addition, as described above, since the user has to continuously twist the two footboards through both feet so as to obtain continuous propelling force, the speed is limited (about 10-15 km) on the flat land, and thus there is a limitation to enjoying the snake board at a higher speed.

### CITATION LIST

### Patent Literature

(Patent Literature 1) Korean Utility Model Publication No. 20-2019-0003996 (2009. Apr. 29.)

(Patent Literature 2) Korean Utility Model Registration No. 20-0430105 (2006. Nov. 13.)

(Patent Literature 3) Korean Patent Registration No. 10-0854094 (2008. Aug. 25.)

### DISCLOSURE

### Technical Problem

The present invention has been made in an effort to solve the above problems of the related art, and an object of the present invention is to provide a snake board apparatus which eliminates an inconvenience in that a user has to repeatedly perform an operation of twisting in a twist direction while putting both feet on the two footboards in order to obtain propelling force.

Another object of the present invention is to provide a snake board apparatus which reduces the risk of safety accidents because a user can easily keep balance in a process of pushing off the ground.

Another object of the present invention is to provide a snake board apparatus which eliminates an inconvenience of rotating a front footboard in parallel with the ground in order to use the snake board apparatus.

Another object of the present invention is to provide a snake board apparatus which allows a user to enjoy riding without fatigue in a process of using the snake board apparatus.

Another object of the present invention is to provide a snake board apparatus which allows a user to easily ride the snake board apparatus regardless of age.

Another object of the present invention is to provide a snake board apparatus which is capable of increase a moving speed.

### Technical Solution

According to one embodiment of the present invention, a snake board apparatus includes: a front footboard part (100) on which a user puts one foot, the front footboard part including: a front footboard (110) provided with beads (112) provided on both edges of an upper surface so as to prevent slipping, and processed parts (114) provided on both edges of a bottom surface so as to reduce a speed of the snake board apparatus; a housing (120) having an opened one side and the closed other side and provided in a length direction of a bottom surface of the front footboard (110); and a roller (130) rotatably provided between both wings (142) of a support bracket (140) fixed to the front footboard (110); a rear footboard part (200) on which a user puts the other foot, the rear footboard part including: a rear footboard (210) provided with beads (112) provided on both edges of an upper surface so as to prevent slipping, and processed parts (114) provided on both edges of a bottom surface so as to reduce a speed of the snake board apparatus; a housing (220) having an opened one side and the closed other side and provided in a length direction of a bottom surface of the rear footboard (210); and a wheel (230) rotatably provided between both wings (242) of a support bracket (240) fixed to the rear footboard (210); and a connecting part (300) connecting the front footboard part (100) and the rear footboard part (200) to each other, the connecting part (300) including: a hollow first finishing member (310) inserted into the housing (120) of the front footboard part (100); a first pipe (320) having one end portion connected to surround a portion of the first finishing member (310) and the other end portion provided with a concave part (322); a second pipe (330) having one end portion integrally provided with a first stopper (332), an outer circumferential surface provided with a coil spring (340), and the other end portion provided with a concave part (334), wherein a locking part (336) is formed at an end portion with a certain interval from the concave part, and second pipe 330 penetrating the first pipe 320 and inserted into the first pipe at a predetermined depth, and the second pipe (330) passes through the first pipe (320) and is inserted into the first pipe by a certain depth; a third pipe (370) having one end portion integrally provided with a third stopper (372) contacting the first finishing member (310), an outer circumferential surface provided with a coil spring (380), and an end portion provided with a locking part (374), wherein the third pipe (370) passes through the second pipe (330) and is inserted into the first pipe (320); a hollow second finishing member (392) inserted through the other end portion of the third pipe (370); a third finishing member (394) having a hollow cap shape and inserted into the second finishing member (392) at a certain depth; and an elastic member (396) having one end portion connected to the first finishing member (310) through the first pipe (320), the second pipe (330), and the third pipe (370), and the other end portion connected to the third finishing member (394) to prevent a separation thereof.

A large buffer member (360) is inserted through the second pipe (330) such that a separation thereof is prevented through the locking part (336), and a small buffer member (390) is inserted through the third pipe (370) such that a separation thereof is prevented through the locking part (374).

A base member (235) having a ring shape is inserted into the wheel (230) through an opening of one side, one end portion of a rotation shaft (231) provided with a tooth member (233) on an outer circumferential surface passes through the base member (235) and is rotatably coupled to the wings (242) of the support bracket (240), a locking protrusion receiving part (234) is formed inside the base member (235), the locking protrusion receiving part (234) is provided with a locking protrusion receiving groove (234a) having a curved shape with a certain curvature at each corner, a spring member insertion groove (234c) is provided adjacent to the locking protrusion receiving groove (234a), the locking protrusion (234b) is received in the locking protrusion receiving groove (234a), and the spring member (236) is inserted into the spring member insertion groove (234c).

### Advantageous Effects

The snake board apparatus of the present invention has the following effects.

First, as the user repeats the operation of pushing the rear footboard 210 by applying force to one foot in a state in which both feet are put on the front and rear footboards 110 and 210, or restoring the rear footboard 210 to the original position by the restoring force of the elastic member 396 in a state in which the user relaxes his or her foot, the snake board apparatus is moved. Therefore, it is possible to eliminate an inconvenience of having to repeatedly perform an operation of twisting in a twist direction while the user puts both feet on the two footboards so as to obtain propelling force.

Second, the user can easily keep balance in the process of pushing off the ground, thereby reducing the risk of safety accident.

Third, when the snake board apparatus is not used, the roller 130 and the wheel 230 are always in parallel with the ground. Therefore, it is possible to eliminate an inconvenience of rotating the front footboard 110 in parallel with the ground in order to use the snake board apparatus.

Fourth, since the user pushes off the ground through his or her foot (right foot), the user may enjoy riding without fatigue in the process of using the snake board apparatus.

Fifth, since the snake board apparatus moves in a state in which both feet are put on the front and rear footboards 110 and 210, the user can easily keep balance according to the use of the snake board apparatus. Therefore, it is possible to easily ride the snake board apparatus regardless of age.

Sixth, as the operation of pushing the rear footboard 210 backward or relaxing the foot is rapidly repeated, the rotating speeds of the roller 130 and the wheel 230 rotate can be increased, thereby increasing the moving speed of the snake board apparatus.

### DESCRIPTION OF DRAWINGS

FIG. 1 is a plan side perspective view showing a snake board apparatus according to an embodiment of the present invention.

FIG. 2 is a rear perspective view showing the snake board apparatus according to the present invention.

FIG. 3 is a side view of the snake board apparatus according to the present invention.

FIG. 4 is a side view showing a state of use of the snake board apparatus according to the present invention.

FIG. 5 is an exploded perspective view showing the configuration of the snake board apparatus according to the present invention.

FIG. 6 is a configuration diagram of a connecting part in the snake board apparatus according to the present invention.

FIG. 7 is a partial enlarged view of one portion of FIG. 6.

FIG. 8 is a partial enlarged view of the other portion of FIG. 6.

FIGS. 9A and 9B are a front view showing a configuration of a wheel in the snake board apparatus according to the present invention.

FIG. 10 is a photograph showing the configuration of the wheel shown in FIGS. 9A and 9B.

FIG. 11 is a perspective view of the wheel shown in FIGS. 9A and 9B.

FIGS. 12A and 12B are a front view for explaining a connection of a fitting member provided in a housing in the snake board apparatus according to the present invention.

### BEST MODE FOR CARRYING OUT THE INVENTION

Hereinafter, a snake board apparatus according to a preferred embodiment of the present invention will be described in detail.

The terms or words as used herein should not be construed as being limited to their usual or dictionary meanings. The terms or words should be interpreted as a meaning and concept consistent with the technical idea of the present invention, based on the principle that the inventors can appropriately define the concept of terms in order to describe their own invention in the best way.

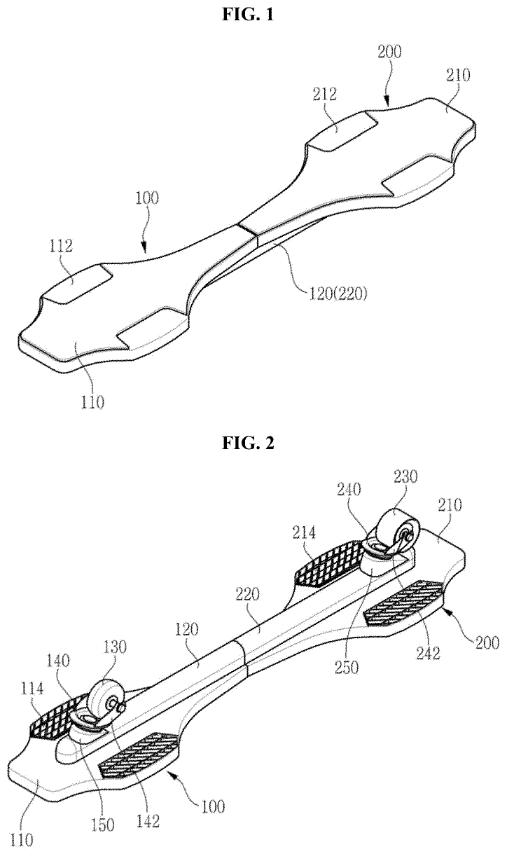

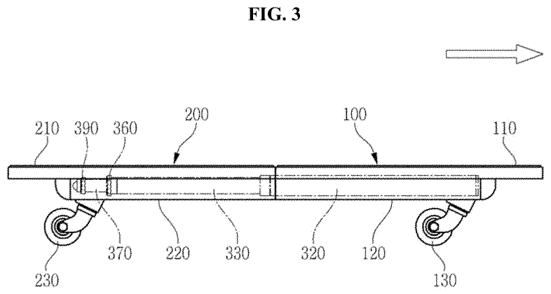

FIG. 1 is a plan side perspective view showing a snake board apparatus according to an embodiment of the present invention, FIG. 2 is a rear perspective view showing the snake board apparatus according to the present invention, and FIG. 3 is a side view of the snake board apparatus according to the present invention.

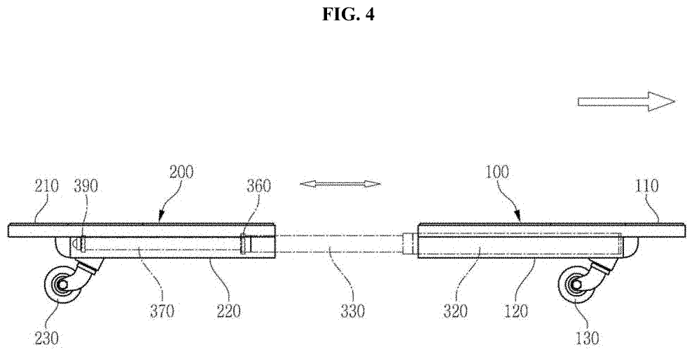

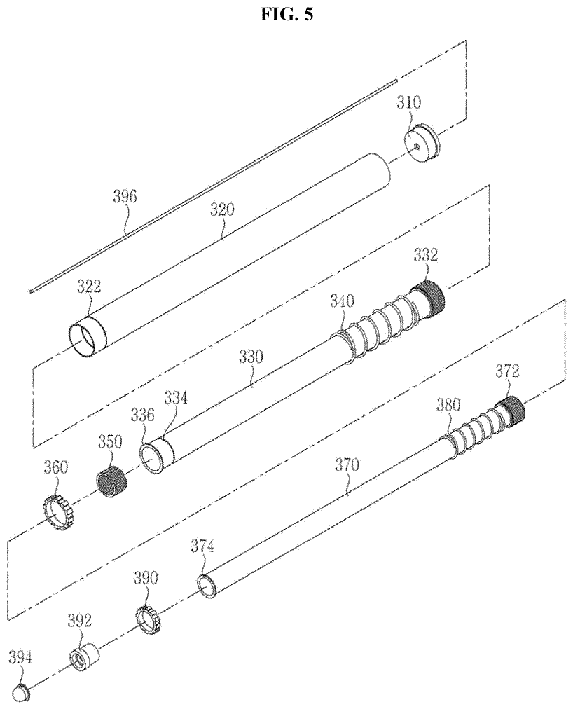

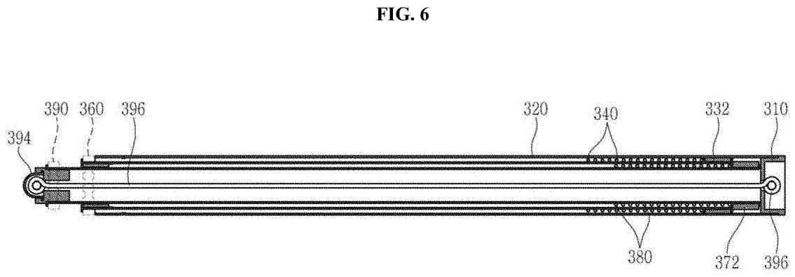

In addition, FIG. 4 is a side view showing a state of use of the snake board apparatus according to the present invention, FIG. 5 is an exploded perspective view showing the configuration of the snake board apparatus according to the present invention, and FIG. 6 is a configuration diagram of a connecting part in the snake board apparatus according to the present invention.

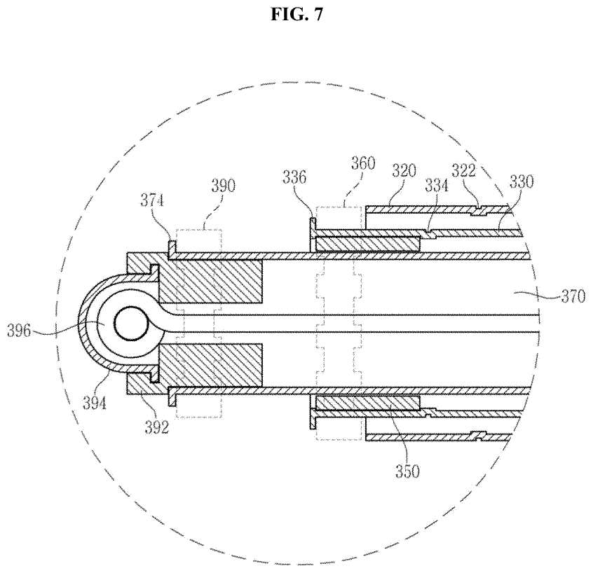

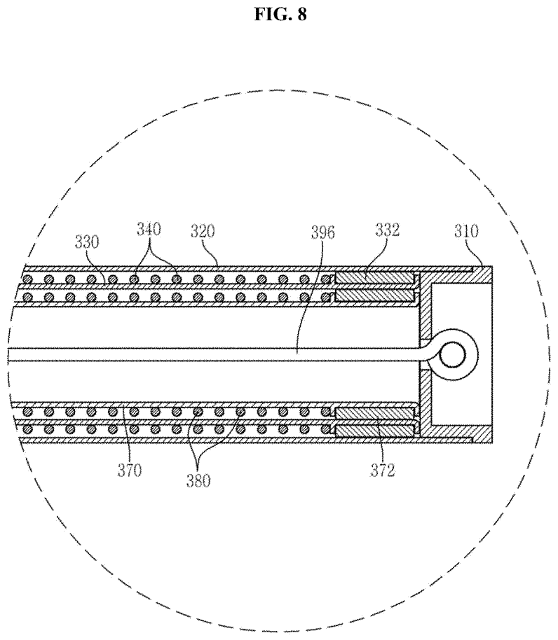

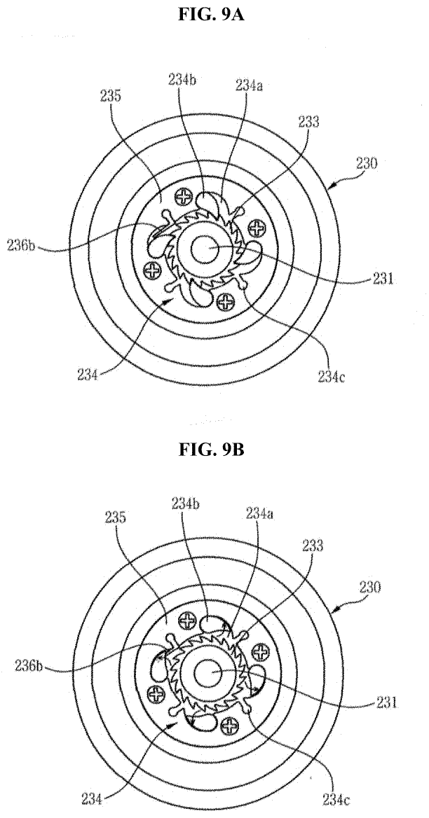

In addition, FIG. 7 is a partial enlarged view of one portion of FIG. 6, FIG. 8 is a partial enlarged view of the other portion of FIG. 6, and FIGS. 9A and 9B are a front view showing a configuration of a wheel in the snake board apparatus according to the present invention.

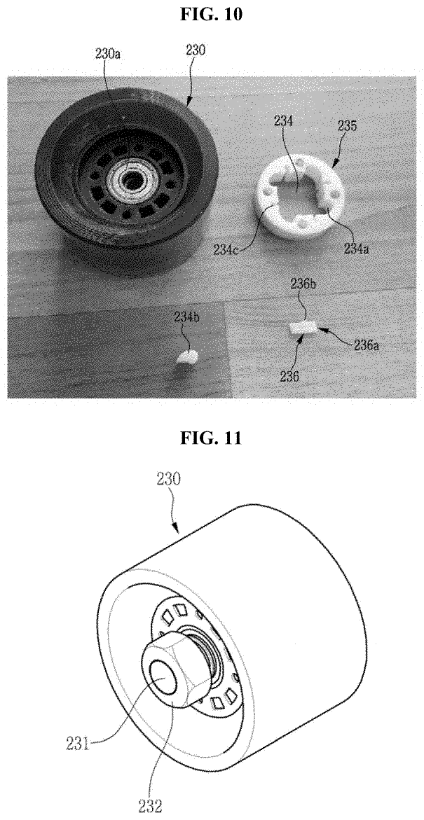

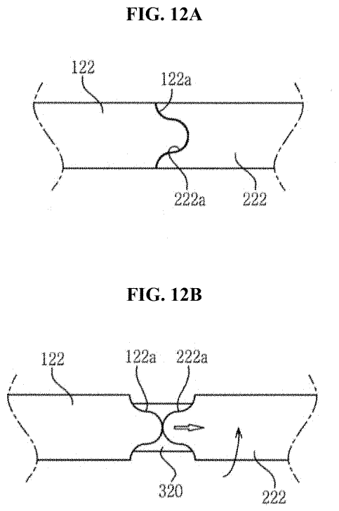

In addition, FIG. 10 is a photograph showing the configuration of the wheel shown in FIGS. 9A and 9B, FIG. 11 is a perspective view of the wheel shown in FIGS. 9A and 9B, and FIGS. 12A and 12B are a front view for explaining a connection of a fitting member provided in a housing in the snake board apparatus according to the present invention.

In the present invention, for convenience, the division between the front and the rear is referred to as a front footboard 110 on the left side and a rear footboard 210 on the right side based on the snake board apparatus shown in FIG. 1.

In addition, arrows shown in FIGS. 3 and 4 indicate the traveling direction of the snake board apparatus.

The snake board apparatus according to an embodiment of the present invention includes a front footboard part 100, a rear footboard part 200, and a connecting part 300 connecting the front and rear footboard parts 100 and 200 to each other.

Referring to FIGS. 1 to 3, a user puts his or her foot (for example, left foot) on the front footboard part 100. Beads 112 for preventing slipping are formed to face each other on both edges of the upper surface of the front footboard 110 having an approximately cross shape with a certain thickness. Grid-shaped processed parts 114 functioning as a brake for reducing the speed of the snake board apparatus are formed to face each other on both edges of the bottom surface of the front footboard 110.

In addition, a housing 120 into which a first pipe 320 of the connecting part 300 to be described later is partially inserted in the length direction of the bottom surface of the front footboard 110 is provided. The housing 120 has a tunnel shape with a certain length. One side of the housing 120 into which the first pipe 320 is inserted is opened and the other side of the housing 120 is closed.

In addition, a roller 130 for allowing the snake board apparatus to travel along the road surface is attached to the bottom surface of the housing 120. The roller 130 is rotatably installed between both wings 142 of a support bracket 140 fixed to the front footboard 110. At this time, the roller 130 is not fixed in one direction, and is formed in a rotating type that can rotate 360 degrees so that the snake board apparatus is easily switched to a desired direction.

Referring to FIGS. 1 to 3, a user puts his or her foot (for example, right foot) on the rear footboard part 200. Beads 212 are formed to face each other on both edges of the upper surface of the rear footboard 210. Processed parts 214 functioning as a brake for reducing the speed of the snake board apparatus are formed to face each other on both edges of the bottom surface of the rear footboard 210.

In addition, a housing 220 into which a second pipe 330 of the connecting part 300 is partially inserted in the length direction of the bottom surface of the rear footboard 210 is provided. One side of the housing 220 into which the second pipe 330 is inserted is opened and the other side of the housing 220 is closed.

In addition, a wheel 230 for allowing the snake board apparatus to travel along the road surface is attached to the bottom surface of the housing 220. The wheel 230 is rotatably installed between both wings 242 of a support bracket 240 fixed to the rear footboard 210. At this time, the wheel 230 has a structure that can only be driven forward according to the traveling of the snake board apparatus (which will be described later).

Referring to FIGS. 4 to 8, the connecting part 300 connects the front and rear footboard parts 100 and 200 to each other. A hollow first finishing member 310 is inserted into the housing 120 of the front footboard part 100. One end portion of the first pipe 320 having a certain diameter is connected to surround a portion of the first finishing member 310, and a concave part 322 having a [symbol] -shaped cross-section is processed at the other end portion of the first pipe 320.

In addition, the second pipe 330 having a diameter less than that of the first pipe 320 passes through the first pipe 320 and is inserted into the first pipe 320 at a certain depth. A first stopper 332 is integrally formed at one end portion of the second pipe 330. A coil spring 340 is provided on the outer circumferential surface of the second pipe 330. A concave part 334 is processed at the other end portion of the second pipe 330. A locking part 336 having a diameter greater than that of the second pipe is formed at the end portion of the second pipe 330 with a certain interval from the concave part 334.

In addition, a second stopper 350 having a hollow ring shape is inserted through the other end portion of the second pipe 330 and caught by the concave part 334. A large buffer member 360 is inserted through the outer circumference of the second pipe 330, such that it is possible to prevent the separation thereof through the locking part 336. At this time, the large buffer member 360 alleviates impact when one end portion of the first pipe 320 contacts the locking part 336.

In addition, a third pipe 370 having a diameter less than that of the second pipe 330 is inserted into the first pipe 320 through the second pipe 330. A third stopper 372 is integrally formed at one end portion of the third pipe 370, such that the third stopper 372 contacts the first finishing member 310 described above.

In addition, a coil spring 380 is provided on the outer circumferential surface of the third pipe 370. A locking part 374 having a diameter greater than that of the third pipe is formed at the end portion of the third pipe 370. A small buffer member 390 is inserted through the third pipe 370 and caught by the locking part 374 to prevent the separation thereof. A hollow second finishing member 392 having an approximately ‘T’-shaped cross-section is inserted through the other end portion of the third pipe 370. A third finishing member 394 having a hollow cap shape is inserted and supported at a certain depth within the second finishing member 392. At this time, the small buffer member 390 alleviates impact when one end portion of the second pipe 330 contacts the locking part 374.

In addition, one end portion of an elastic member 396 having a certain diameter is connected to the first finishing member 310 through the first, second, and third pipes 320, 330, and 370. The other end portion of the elastic member 396 is connected to the third finishing member 394 to prevent the separation thereof. The elastic member 396 is not particularly limited, but is preferably an elastic string or an elastic rope.

Referring to FIGS. 9A to 11, the wheel 230 is provided with a bearing 230a and is rotatable through the bearing 230a. A base member 235 having a ring shape with a certain thickness is inserted through an opening formed at one side. One end portion of a rotation shaft 231 passes through the base member 235 and the bearing 230a, is screwed to a bolt member 232, and is rotatably connected to the wing 242 of the support bracket 240. At this time, a tooth member 233 of one direction (for example, counterclockwise) is integrally fixedly attached to the outer circumferential surface of the rotation shaft 231.

In addition, a locking protrusion receiving part 234 is formed in the inside of the base member 235. The locking protrusion receiving part 234 has a substantially rectangular shape as a whole. The locking protrusion receiving part 234 includes a locking protrusion receiving groove 234a having a curved shape with a certain curvature at each corner, and a spring member insertion groove 234c which is formed adjacent to the locking protrusion receiving groove 234a and into which a spring member 236 to be described later is inserted.

In addition, locking protrusions 234b having an approximately water droplet-shaped cross-section are respectively accommodated in the locking protrusion receiving grooves 234a, and the spring member 236 is inserted into the spring member insertion groove 234c. However, the spring member 236 has a protrusion 236b standing on one side of the main body 236a having an approximately keyhole-shaped cross-section.

Accordingly, referring to FIGS. 9A and 9B, when the roller 130 of the snake board apparatus moves forward, the wheel 230 also rotates forward. Thus, as the tooth member 233 rotates clockwise as shown in FIG. 9B, the toothed member 233 comes into contact with the locking protrusion 234b and pushes the locking protrusion 234b and the protrusion 236b of the spring member 236. In this manner, the wheel 230 rotates forward.

On the contrary, when a user tries to move the snake board apparatus backward, the roller 130 moves backward. However, as shown in FIG. 9A, the tooth member 233 rotates counterclockwise. Thus, the protrusion 236b of the spring member 236 pushes the locking protrusion 234b such that the locking protrusion 234b is caught between the tooth members 233. Therefore, the backward rotation of the wheel 230 is not performed. In this manner, the snake board apparatus has a structure that can only be driven forward.

Referring to FIGS. 12A and 12B, fitting members 122 and 222 may be provided between the two pipes 320 and 330 and the two housings 120 and 220 so as to have a horizontal state when the snake board apparatus is not used. That is, the hollow fitting members 122 and 222 made of synthetic resin are respectively fitted into the two housings 120 and 220, and the two pipes 320 and 330 are respectively accommodated in the fitting members 122 and 222. In this state, portions of the fitting members 122 and 222 facing each other protrude from the two housings 120 and 220 by a certain length. The protrusions have curved portions 122a and 222a having an approximately ‘U’ shape.

Accordingly, for example, when the snake board apparatus is used, as shown in FIG. 12B, the curved parts 122a and 222a respectively provided in the front footboard part 100 and the rear footboard part 200 face each other by the twist motion. At this time, the front footboard part 100 and the rear footboard part 200 are not in parallel with the ground and are in a state of being misaligned with respect to the first pipe 320 as an axis.

On the contrary, when the snake board apparatus is not used, as shown in FIG. 12A, as a user brings the front footboard part 100 and the rear footboard part 200 in close contact with each other, the curved parts 122a and 222a respectively provided in the front footboard part 100 and the rear footboard part 200 are mated with each other in twist contact with each other. At this time, the front footboard part 100 and the rear footboard part 200 are in parallel with the ground. In this way, it is possible to maintain the horizontal state of the snake board apparatus while the front footboard part 100 and the rear footboard part 200 are in close contact with each other. Reference numerals 150 and 250 in FIG. 2 denote base members to which the support brackets 140 and 240 are pin-coupled.

Hereinafter, the operation of the present invention having the above configuration will be described.

Referring to FIGS. 1 and 2, the third pipe 370 according to the present invention is accommodated in the second pipe 330, and the second pipe 330 is accommodated in the first pipe 320. The front and rear footboards 110 and 210 and the housings 120 and 220 are in contact with each other. The elastic member 396 is in a state in which the length thereof is reduced by the restoring force.

In addition, when the snake board apparatus is not used, the curved parts 122a and 222a respectively provided in the front footboard part 100 and the rear footboard part 200 are mated with each other. The front footboard part 100 and the rear footboard part 200 are in parallel with the ground. The roller 130 and the wheel 230 are always maintained in a state of being parallel to the ground. Therefore, an inconvenience of rotating the front footboard 110 in parallel with the ground in order to use the snake board apparatus is eliminated.

In addition, although not shown in the drawings, when a connecting means (for example, a rubber band) having an elastic material is coupled between the wings 142 and 242 and the housings 120 and 220, the roller 130 and the wheel 230 can always have a straight line shape even when the snake board apparatus is not used.

In this state, a user put his or her left foot on the front footboard 110 and his or her right foot on the rear footboard 210. After that, when the user pushes the rear footboard 210 backward through his or her right foot while applying force to both feet, the elastic member 396 is stretched. When the user relaxes his or her right foot, the two footboards 110 and 210 are restored to the original positions by the restoring force of the elastic member 396. As these operations are sequentially repeated, the elastic member 396 expands or contracts by itself.

In addition, in conjunction with this, the third pipe 370 is repeatedly received in or separated from the second pipe 330, and the second pipe 330 is repeatedly received in or separated from the first pipe 320. Therefore, as the roller 130 and the wheel 230 rotate, the snake board apparatus moves in one direction (forward).

In other words, as the operation of pushing the rear footboard 210 backward through the right foot or relaxing the foot in a state in which both feet are put on the front and rear footboards 110 and 210 is sequentially repeated, the snake board apparatus may move while self-propelling force is generated in the two footboards 110 and 210. Therefore, the user can move in a desired direction while riding the snake board apparatus. The footboards 110 and 210 are twisted along the outer circumferential surfaces of the first pipe 320 and the second pipe 330.

At this time, as the user increases the propelling force by rapidly repeating the operation of pushing the rear footboard 210 backward by applying force to his or her right foot or relaxing his or her foot, the speed of the roller 130 and the wheel 230 rotating in one direction (forward) is increased. Therefore, the moving speed of the snake board apparatus may be increased. If necessary, when the processed parts 114 and 214 are brought into contact with the ground, the snake board apparatus is braked to reduce the speed of the snake board apparatus.

On the other hand, when the roller 130 moves forward while the snake board apparatus moves in one direction (forward), the wheel 230 also rotates forward. Thus, as the tooth member 233 rotates clockwise as shown in FIG. 9B, the toothed member 233 comes into contact with the locking protrusion 234b and pushes the locking protrusion 234b and the protrusion 236b of the spring member 236. In this manner, the wheel 230 rotates forward.

When the user tries to move the snake board apparatus backward, the roller 130 moves backward. However, as shown in FIG. 9A, the tooth member 233 rotates counterclockwise. Thus, the protrusion 236b of the spring member 236 pushes the locking protrusion 234b such that the locking protrusion 234b is caught between the tooth members 233. Therefore, the backward rotation of the wheel 230 is not performed.

According to the present invention in the above process, as the user repeats the operation of pushing the rear footboard 210 by applying force to one foot in a state in which both feet are put on the front and rear footboards 110 and 210, or restoring the rear footboard 210 to the original position by the restoring force of the elastic member 396 in a state in which the user relaxes his or her foot, the snake board apparatus is moved. Therefore, it is possible to eliminate an inconvenience of having to repeatedly perform an operation of twisting in a twist direction while the user puts both feet on the two footboards.

Therefore, the user can easily keep balance in the process of pushing off the ground, thereby reducing the risk of safety accident.

In addition, when the snake board apparatus is not used, the roller 130 and the wheel 230 are always in parallel with the ground. Therefore, it is possible to eliminate an inconvenience of rotating the front footboard 110 in parallel with the ground in order to use the snake board apparatus.

In addition, since the user pushes off the ground through his or her foot (right foot), the user may enjoy riding without fatigue in the process of using the snake board apparatus.

In addition, since the snake board apparatus moves in a state in which both feet are put on the front and rear footboards 110 and 210, the user can easily keep balance according to the use of the snake board apparatus. Therefore, it is possible to easily ride the snake board apparatus regardless of age.

In addition, as the operation of pushing the rear footboard 210 backward or relaxing the foot is rapidly repeated, the rotating speeds of the roller 130 and the wheel 230 rotate can be increased, thereby increasing the moving speed of the snake board apparatus.

While the snake board apparatus according to the present invention has been described with reference to the accompanying drawings, the present invention is not limited by the embodiments and drawings disclosed herein. It will be understood that various modifications can be made thereto by those of ordinary skill in the art within the scope of the technical idea of the invention.

### EXPLANATION OF REFERENCE NUMERALS

| | |
|---|---|
| 100: front footboard part | 110: front footboard |
| 120, 220: housing | 130: roller |
| 200: rear footboard part | 210: rear footboard |
| 230: wheel | 300: connecting part |
| 310: first finishing member | 320: first pipe |
| 330: second pipe | 340, 380: coil spring |
| 370: third pipe | 392: second finishing member |
| 394: third finishing member | 396: elastic member |

1. A snake board apparatus comprising:
a front footboard part on which a user puts one foot, the front footboard part including:
a front footboard provided with beads provided on both edges of an upper surface so as to prevent slipping, and processed parts provided on both edges of a bottom surface so as to reduce a speed of the snake board apparatus;
a housing having an opened one side and the closed other side and provided in a length direction of a bottom surface of the front footboard; and
a roller rotatably provided between both wings of a support bracket fixed to the front footboard;
a rear footboard part on which a user puts the other foot, the rear footboard part including:
a rear footboard provided with beads provided on both edges of an upper surface so as to prevent slipping, and processed parts provided on both edges of a bottom surface so as to reduce a speed of the snake board apparatus;
a housing having an opened one side and the closed other side and provided in a length direction of a bottom surface of the rear footboard; and
a wheel rotatably provided between both wings of a support bracket fixed to the rear footboard; and
a connecting part connecting the front footboard part and the rear footboard part to each other, the connecting part including:
a hollow first finishing member inserted into the housing of the front footboard part;
a first pipe having one end portion connected to surround a portion of the first finishing member and the other end portion provided with a concave part;
a second pipe having one end portion integrally provided with a first stopper, an outer circumferential surface provided with a coil spring and the other end portion provided with a concave part, wherein a locking part is formed at an end portion with a certain interval from the concave part, and second pipe penetrating the first pipe and inserted into the first pipe at a predetermined depth, and the second pipe passes through the first pipe and is inserted into the first pipe by a certain depth;
a third pipe having one end portion integrally provided with a third stopper contacting the first finishing member, an outer circumferential surface provided with a coil spring, and an end portion provided with a locking part, wherein the third pipe passes through the second pipe and is inserted into the first pipe;
a hollow second finishing member inserted through the other end portion of the third pipe;
a third finishing member having a hollow cap shape and inserted into the second finishing member at a certain depth; and
an elastic member having one end portion connected to the first finishing member through the first pipe the second pipe and the third pipe, and the other end portion connected to the third finishing member to prevent a separation thereof.

2. The snake board apparatus of claim 1, wherein a large buffer member is inserted through the second pipe such that a separation thereof is prevented through the locking part, and
a small buffer member is inserted through the third pipe such that a separation thereof is prevented through the locking part.

3. The snake board apparatus of claim 1, wherein a base member having a ring shape is inserted into the wheel through an opening of one side,
one end portion of a rotation shaft provided with a tooth member on an outer circumferential surface passes through the base member and is rotatably coupled to the wings of the support bracket,
a locking protrusion receiving part is formed inside the base member,
the locking protrusion receiving part is provided with a locking protrusion receiving groove having a curved shape with a certain curvature at each corner,
a spring member insertion groove is provided adjacent to the locking protrusion receiving groove,
the locking protrusion is received in the locking protrusion receiving groove, and
the spring member is inserted into the spring member insertion groove.
